(19) United States
(12) Patent Application Publication
(10) Pub. No.: US 2005/0190769 A1
(43) Pub. Date: Sep. 1, 2005

(54) System and method for securing remote access to a remote system

(76) Inventor: B. Scott Smith, Center Barnstead, NH (US)

Correspondence Address: BOURQUE & ASSOCIATES, P.A., 835 HANOVER STREET, SUITE 303, MANCHESTER, NH, 03104, US

(21) Appl. No.: 11/045,801

(22) Filed: Jan. 28, 2005

Related U.S. Application Data
(60) Provisional application No. 60/539,899, filed on Jan. 28, 2004.

(51) Int. Cl. H04L 12/28

(52) U.S. Cl. 370/395.2

(57) ABSTRACT

A system and method that provides secure, remote access and/or control to remotely located software and/or hardware. A third party logs into a support server with a valid log in and password. The third party requests that the support server application program generate a key which the third party ultimately transmits to a customer or user. The customer enters the key into a software component operating on the customer's computer which initiates an encrypted connection to the support server. The third party then attaches to the customer session which initiates an encrypted connection to the customer or computer through the support server. The actions of the third party are logged or tracked by the support server for auditing purposes and possible review by the customer. Accordingly, the user or customer can control the connection on an outward basis, thereby not requiring a potentially dangerous security “opening” into the user's network.

### RELATED APPLICATION

The present application is a continuation of and claims priority from U.S. Provisional Patent Application No. 60/539,899 filed Jan. 28, 2004 and incorporated herein fully be reference.

### TECHNICAL FIELD OF THE INVENTION

The present invention relates to remote computer hardware and software support and more particularly, to a system and method for providing secure remote access to a remote computer system that is initiated by a server and not a remote user.

### DESCRIPTION OF THE RELATED ART

Technology companies, computer hardware and software support providers, and others (collectively referred to herein as support providers), must regularly access computer software or hardware remotely to provide support and maintenance. This is particularly true when complex software is sold or installed on a company wide “enterprise” bases. With heightened security procedures and the proliferation of corporate firewalls, these support providers are frequently prohibited from accessing the software or hardware sought to be supported or are forced to rely on ineffective methods for gaining remote access to their software or products. These disadvantages have caused service delays and on occasion have forced key support personnel to deliver on-site support.

The need to remotely connect with software applications for maintenance and support has spawned a number of methods to accomplish the task. These methods include telephone support, log-file transfer and replay, screen sharing, Internet tunneling, modem dial-in, and Virtual Private Networks (hereafter “VPN”), to name a few. Other methods involve a client initiated log in to a support server computer.

These methods of remotely connecting to a customer's system, however, often require the customer to compromise its normal security protocols to allow the remote connection to take place. This compromise, for example, may be a “hole” opened up in a firewall, a screen sharing session that is awaiting a remote connection, or a modem that is kept turned on and ready to accept an incoming connection.

One of the greatest challenges in allowing remote access is controlling and monitoring the level of access granted. Some options, such as WebEx, are connected through a central server while others allow connectivity directly from the remote user into the customer's network. Once directly connected, there are no filters in place for monitoring activities or to prevent network snooping, unauthorized access to additional ports or services, or trade secret theft.

Screen sharing solutions, such as WebEx, GoToMyPC or pcAnywhere, grant the remote user the same permissions as a local user. If this user has only basic access, the support agent may not be able to effectively accomplish his or her task. If the user has full permission or unfettered access, such as the ability to delete files, remote screen sharing has significant disadvantages and can be extremely dangerous.

With regard to programs such as pcAnywhere, it is a piece of inexpensive software that enables a remote user to gain control of a desktop via an Internet or modem connection. While the software was not specifically designed to be a technical support tool, many companies use it as a method of “seeing” what the customer is experiencing and taking over the customer's desktop. However, using pcAnywhere requires a customer to create and leave a hole in its firewall open to the outside, awaiting the connection. Any time a hole in the firewall is left open, a security threat is present, and this is a significant disadvantage and not desirable.

A VPN is commonly used to enable remote users to access a corporate network. When maintenance and support is required, for example, the customer creates an extension of its private network that is acceptable by the company providing the support. Further, any additional remote log-ins creates additional security risks. Even with a login disabled, the remote user still has the client configuration information that could be used to access the customer's network.

With regard to programs and methods such as WebEx and GoToMyPC, these programs are a screen sharing service that enables two or more users to view and/or control another PC desktop remotely. While the service was not specifically designed to be a technical support tool, many companies use it as a method of “seeing” what the customer is experiencing and sometimes taking over the customer's desktop.

Accordingly, there is a need for a secure system and method for allowing controlled access to a server and other network devices, including the software running on such hardware, by and from a remote user, and wherein such access is initiated from that server and not the remote user. Moreover, there is a need for a secure system and method for remotely connecting with software applications for maintenance and support.

### SUMMARY OF THE INVENTION

The present invention is a novel, secure system and method for allowing remote access and/or control to remotely located software and/or hardware. According to the present invention, the party requiring support (often referred to herein as a customer) initiates and ultimately controls a connection to a support server using a secure key and/or password. A support representative (often referred to herein as remote user) also initiates a connection to the support server. The connection between the customer and the support representative is provided through and controlled/restricted by the support server, according to the present invention. Because the connection to the support server from both the user and customer is initiated as an outward (outbound) request, no potentially dangerous inbound access (firewall holes) to the customer's network is necessary.

The system and method of the present invention is applicable to many different applications and situations that require remote access to a system. For example, the present invention is applicable to the situation where a software maintenance and support company needs remote access to a customer's system. Further, the invention is applicable when a partner or vendor of the customer requires temporary, controlled and restricted access to the customer's system. The following describes the present invention in the context of a software maintenance and support company supporting a customer however, this is not a limitation of the present invention and the invention is equally applicable to any other situation wherein remote access to a system is desired and wherein the connection is initiated from that system (the customer's system) and not by the remote user.

In one embodiment of the invention, the system and method is utilized in a software maintenance and support application. The system and method of the present invention has an application program (software) that runs on a support server that allows remote, controlled access by the software maintenance and support company to a customer's system, and which connection is controlled by the server and not the remote user. Connection software is also found on a computer or server at the customer site. The connection software runs in a browser window and serves as a Graphical User Interface (GUI) to the system of the present invention; forms the physical connection to the support server; and controls services to be provided by the system including, but not limited to file transfer, desktop sharing, access to operating system command prompt, and acts as a network gateway or proxy (with or without authentication) to the network services on the customer's network. The system and method of the invention secures remote access for a software maintenance and support company to its customer's system, which is initiated by the customer's system and then connected through and controlled/restricted by the remote support server where a portion of the software that forms part of the present invention resides.

With this system and method, a customer initiates and controls the maintenance and/or support session. The customer requests and receives a secure session via a one-time, permanent or anytime access key. After the key is entered, the method and system of the present invention provides remote access to the customer's software or product during the period defined by the key. During remote access, a level of access is determined and granted to the software company providing support and/or maintenance to the customer. The system and method of the present invention further provides audit and reporting features, thereby providing maximum security and functionality for remote maintenance and support.

It is important to note that the present invention is not intended to be limited to a system and/or method which must satisfy one or more of any stated or implied objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the allowed claims.

### BRIEF DESCRIPTION OF THE DRAWINGS

These and other features and advantages of the present invention will be better understood by reading the following Detailed Description and accompanying pages taken together with the drawing wherein:

FIG. 1 is a block diagram illustrating the configuration of a system according to the present invention.

### DETAILED DESCRIPTION

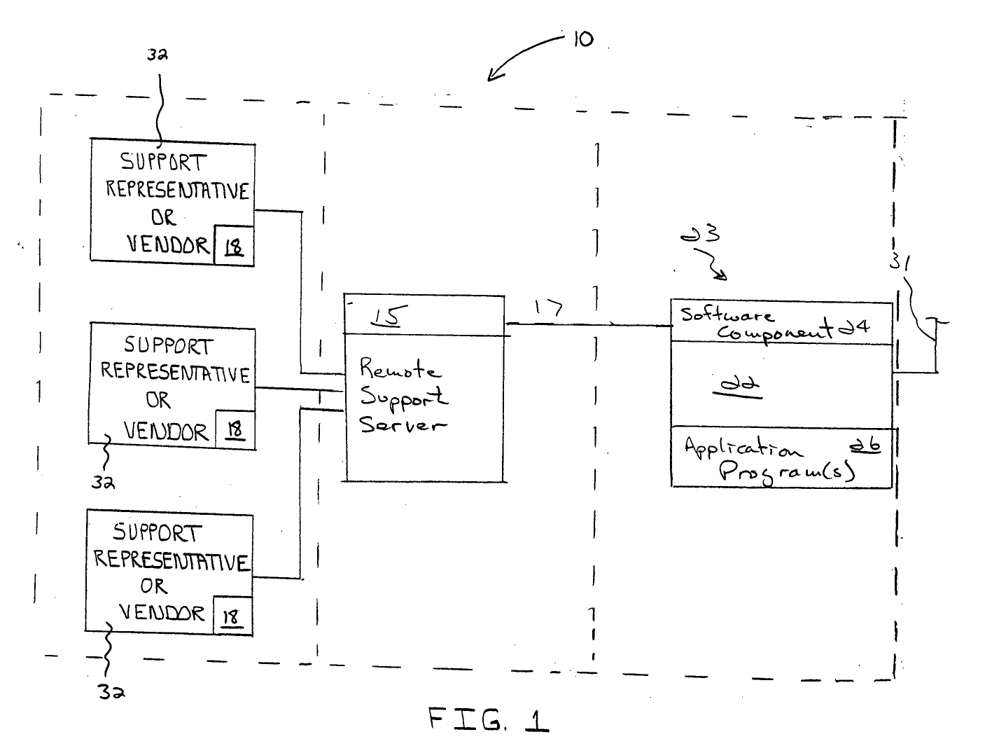

The present invention is a system and method, indicated generally at 10, FIG. 1, for securing a remote access connection to a user or customer's software or hardware 23, which connection is initiated by the customer 23 yet controlled by a remote support server 20. The preferred embodiment of the system and method 10 of the present invention includes computer software 15 operating on the remote support server 20. The remote server is typically located physically at the site of the support vendor, but this is not a limitation of the present invention. The present invention interfaces with at least one support representative or remote user system 32 and a user or customer server 22, typically having a software component for connecting to the software component 24 of the present invention which resides on the customer server/computer (such as a typical internet browser such as Netscape or Internet Explorer, and one or more customer applications 26 which need supporting.

Accordingly, the present invention allows the customer 23 to request a secure link or connection between their computer or server 22 and the support representative 32. The remote support server 20, typically located in the support representative's support center, generates a unique “key” that, when entered by the customer, and in combination with the software component 24 resident at the customer site, creates an encrypted connection that enables the support representative 32 to gain access to the user's 23 application 26 (or hardware) without the user 23 having to leave “open” a hole or other entry point into the user's 23 network/system.

The remote support server 20 utilizes secure shell software (SSH) based and port forwarding technologies as will be described below, and essentially acts as a “switchboard” between a connection initialed by the customer/user 23 and a connection initiated by the at least one support representative 32.

The present invention also includes a computer software component 24 installed on the customer server/computer 22. The software component 24 is installed at the customer's site during initial installation of the system according to the present invention.

In operation, the present invention has the support representative 32 log into the remote support server 20 (a login UserID and password having previously been defined by the administrator of the remote support server 20) using a standard browser, and select the appropriate on screen “button” or “tab” marked “create connection” or “secure connection key” or like indicator, which generates a secure connection key (hereinafter “the key”). The support representative 32 provides the key to the customer 23 prior to the customer's connection request via a communication medium (e.g., email, telephone, instant messaging/chat or the like).

There are three types of “keys” that the system may provide. The first type of key is restricted in the length of time that it will be valid. For example, the time restricted key may have to be entered within a preprogrammed period of time such as 15 minutes. The key must be used by the customer 23 within a certain, configurable time period to establish a secure, encrypted connection link with the remote support server 20. For example, the time period may be fifteen minutes, although this time is configurable. With this type of key, every time a support is required, the remote user 32 must log into the remote server 20 and obtain a new key which is transmitted to the customer.

The next type of key is called a permanent key. With a permanent key, the remote user 32 does not need to transmit the key information to the customer but rather, the key remains active permanently. Then, anytime the customer requires support, he or she will enter in the same permanent “key” previously given to them. In another embodiment using the permanent key, the permanent key is entered by the customer and is remembered by the software component 24 and/or remote server 20 which form part of the present invention. Subsequently, when the customer require support, he or she uses a browser to access the software component 24 which instead of presenting a screen in which to enter the key, a screen is presented with a “button” which is marked “connect” or the like. Thus, when the customer requires support, he or she opens the software component 24 of the present invention and simply has to click the “connect” button to establish a connection with the support representative 32 through the remote server 20. Accordingly, using the permanent key, a connection is still initiated by the customer but the need to always enter a “key” may be eliminated.

Lastly, the third type of key configuration is referred to as an anytime access key. The anytime access key requires the issuance of a permanent key as described above however, the customer may not have to be present to initiate the connection, although the connection is still initiated by the customer's server. With this type of key, the software component 24 on the customer server 23 periodically “polls” the support server 20 to see if the support server wants to form a connection with that particular customer. Once the support server identifies that a connection is desired to be established (as a result of a support representative 32 logging on to the remote support server 20 and requesting a connection), a secure connection is initiated. The anytime access key is controlled by the customer 23. The limited access key may be valid for a period of time (for example 24 hours or one-week) or may be valid for an indefinite period of time. Although this mode does not require the customer to the present, the connection to the remote support server 20 is still an outbound connection and therefore the security and integrity of the connection is maintained as described herein and with regard to other types of keys.

With any type of key, the customer may decide to have the service of the present invention password protected. The software component 24 of the present invention allows the customer to establish or set up, if desired, a password to be entered in combination with the key. In this manner, the customer may even control who is allowed to initiate the remote connection.

The customer brings up the software component 24 interface through a standard browser, and inputs the supplied key and/or hits the “connect” button if one of the first 2 key modes are utilized (i.e. not the unlimited access key mode). A secure, encrypted connection 17 is then formed from the customer server 22 (via the software component 24) to the securelink server 20. Since the customer initiates the secure connection request, the connection will not be blocked by any firewall, router or other device or system at the customer's site.

The support representative 32 then “attaches” to the connection, which now allows the representative to access the remote customer services as if they were on his local desktop. The connection link or session is connected through and monitored by the securelink remote support server 20.

The support representative 32 may attach to the connection at any time after the customer has connected to the remote support server 20, provided the customer 23 is connected and has not disconnected or terminated the connection. The key is used as a secure, temporary access mechanism, not to restrict access (access restrictions are in the properties file under the control of the customer 23) but rather as a control mechanism to ensure that a connection is established only upon the appropriate conditions that are initiated and controlled only by the customer.

The software component 24 may be configured to limit the support representative's access to the customer server 22. For example, the software component 24 may limit access to certain “ports” on the customer's server 22, which ports in turn may limit access to certain storage devices, file directories, screen sharing files, proprietary files, etc. on the user's server 22.

In the preferred embodiment, the software component 24 runs in a browser window of the customer server or other computer 22, and serves as a Graphical User Interface (GUI) to the system of the present invention. The software component 24 controls and forms the physical connection to the support server 20 and also controls services to be provided/allowed by the system of the present invention including, but not limited to file transfer, from the customer server at 22, desktop sharing and access to the server operating system command prompt. The software component 24 also acts as a network gateway or proxy (with or without authentication) to the network services on the customer's network.

In the preferred embodiment, the present invention attempts to establish an outbound connection to the remote support server 20 using a direct SSH based connection through the customer's firewall (not shown but well known). If, however, this is not possible due to strict firewall restrictions, the software component 24 of the present invention may operate with at least an HTTP connection to the support server 20. Through the HTTP connection, encapsulated data may be sent using a proxy server with or without authentication. Although this mode is slower than an SSH based connection, a feature of the present invention is that all is required is at least an HTTP connection to the internet that will be used to connect to the support server 20.

When the support representative 32 accesses the remote support server 20, a java applet is launched from the browser. The support representative 32 accessing the customer server 22 must enter a user ID and password. The entered information is used for managing, controlling, auditing, tracking, and monitoring the support representative's access of the customer's computer 22.

The communication between the customer server 22 and the remote support server 20 is encrypted over the World Wide Web or other public network. After the customer 23 connects to the remote support server 20, the support representative 32 can access the designated ports of the customer server 22, as well as designated ports/services running on other servers within the customer's network 31. The key may have a session expiration time associated with it (e.g., two hours) and, if so, upon the expiration of this time period, the communication will be terminated. Further, the customer 23 or the support representative 32 may terminate the communication at any time.

Once the support representative 32 establishes connection with the customer server 22, the support representative 32 has direct access to the customer's server 22. Further, indirect access to other services (i.e., Telnet, and database query access) on the customer's network is possible if approved by the customer 23. Therefore, it is not necessary to install the software component 24 on the customer server 22 to which the support representative 32 needs access, as the support representative 32 can still access many services through the software component 24 functioning as a network gateway.

A number of support representatives 32 may connect to the remote support system 20 simultaneously. The remote support system 20 is centralized and all access is routed though one connection even if a multiple service representatives 32 are accessing the same customer server 22.

The remote support server 20 of the system and method 10 according to the present invention has reporting and auditing capabilities. The remote support server 20 can determine and log the files accessed and transferred by each support representative 32. For example, the screenshots shown in FIGS. 2A and 2B examples of some of the auditing capabilities.

The system and method of the present invention is applicable to many different applications and situations that require remote access to a system. Although the present invention is described in the context of a software maintenance and support company—customer scenario, this is not a limitation of the present invention.

As mentioned above, the present invention is not intended to be limited to a device or method which must satisfy one or more of any stated or implied objects or features of the invention and is not limited to the preferred, exemplary, or primary embodiment(s) described herein. Modifications and substitutions by one of ordinary skill in the art are considered to be within the scope of the present invention, which is not to be limited except by the allowed claims.

1. A system for providing a user initiated, secure data connection between a user and a second party, comprising:
a remote server;
a user computer including a hardware component and at least one software component, wherein said user computer may be directed to couple to said remote server;
a second party computer, wherein said user computer may be directed to couple to said remote server; and
wherein said remote server provides at least an access key which, when entered by a user at said user computer, causes said user computer software component, in cooperation with said remote server, to provide a data connection from said second party computer to said user computer through said remote server.

2. The system of claim 1 wherein said user computer includes a user server.

3. The system of claim 1 wherein said user computer further includes an application program.

4. The system of claim 3 wherein said second party includes a remote support personnel, and wherein said data connection is provided to allow said remote support personnel to provide remote support to said user application program on said user computer.

5. The system of claim 1 wherein said data connection is encrypted.

6. The system of claim 1 wherein said user computer is coupled to said remote server over a public connection selected from the group consisting of a telephone line, the World Wide Web, a local area network connection, and a wide area network connection.

7. The system of claim 1 wherein said second party computer is coupled to said remote server over a public connection selected from the group consisting of a telephone line, the World Wide Web, a local area network connection, and a wide area network connection.

8. The system of claim 1 wherein said at least an access key is generated by said remote server upon request by said second party, and wherein said second party transmits said at least an access key to said user at said user computer, for entry into said user computer.

9. The system of claim 8 were in said at least an access key is entered into said user computer software component operating on said user computer.

10. The system of claim 1 wherein said access key is selected from the group consisting of a time limited access key, a permanent key and an anytime access key.

11. The system of claim 1 wherein said user computer software component attempts to connect to said remote server using an SSH based connection.

12. The system of claim 11 wherein said user computer software component attempts to connect to said remote server using an HTTP connection if said attempt to connect to said remote server using an SSH based connection fails.

13. A system for providing a user initiated, secure data connection between a user and a second party, comprising:
a remote server;
a user computer including a hardware component and at least one software component, wherein said user computer may be directed to couple to said remote server;
a second party computer, wherein said second party computer may be directed to couple to said remote server; and
wherein said remote server provides at least an access key, wherein said at least an access key is generated by said remote server upon request by said second party, and wherein said second party transmits said at least an access key to said user at said user computer, for entry into said user computer software component operating on said user computer which, wherein when said at least an access key is entered by a user at said user computer, causes said user computer software component, in cooperation with said remote server, to provide said encrypted data connection from said second party computer to said user computer through said remote server.
